(19) United States
(12) Patent Application Publication
(10) Pub. No.: US 2009/0177752 A1
(43) Pub. Date: Jul. 9, 2009

(54) System and Method for Processing User Input

(76) Inventor: Richard B. Himmelstein, Kure Beach, NC (US)

Correspondence Address: Lech Law, LLC, P.O. Box 3473, Dublin, OH, 43016, US

(21) Appl. No.: 12/264,236

(22) Filed: Nov. 3, 2008

Related U.S. Application Data
(60) Provisional application No. 60/984,496, filed on Nov. 1, 2007.

(51) Int. Cl. G06F 3/048; G06F 15/16

(52) U.S. Cl. 709/206; 715/780

(57) ABSTRACT

Systems and methods for processing user input are provided. In one example method, a method for accepting at least one contact identifier as input data in a social networking system is disclosed. The method comprises: providing a text box to a first account holder, the text box enabling the first account holder to input the at least one contact identifier as an input string; receiving the input string from the first account holder; parsing the input string to identify each of the at least one contact identifiers contained within the input string; categorizing each contact identifier by category; associating each contact identifier with the first account holder; and storing each contact identifier for use at a subsequent time.

### CROSS REFERENCE TO RELATED APPLICATIONS

Pursuant to 35 U.S.C. § 120, this application claims priority from U.S. Patent Application No. 60/984,496, filed Nov. 1, 2007, which is incorporated herein by reference in its entirety.

### FIELD OF INVENTION

The present application relates to systems and methods for obtaining and processing input from a user of a computer system or software application. More particularly, the present application relates to a system and method for using a text input box to obtain and process identifying information.

### BACKGROUND

In recent years, there has been an increase in use of computing technology, such as computers, computer systems, networks and software applications (collectively “social networking system”), to establish and maintain social networks. A number of social networking Internet sites, including MySpace.com, Linkedln.com, Reunion.com and Plaxo.com, for example, enable users to create, maintain and join established communities. A typical feature of such sites is to enable a user to establish some type of link with at least one other user, for example by sending an invitation to join the user's social network.

According to one typical method for establishing such a link, a first user may invite a second user to join a community and/or to establish a link with the first user. As an example, the social networking site Linkedln enables a user to enter up to 5 e-mail address fields and 5 corresponding name fields for the system to generate an e-mail invitation to each invitee.

Another social networking company, Plaxo, initially allowed a user to import his/her e-mail contact list. Once the user's e-mail contact list had been imported, the Plaxo system would send an e-mail to each contact in the list, asking each contact to update his/her information. Many Plaxo users complained that this technique encouraged the distribution of unwanted e-mail messages, commonly known as “spam.” Further, under the Plaxo system, contacts of Plaxo users often received multiple invitations from Plaxo's users.

There is a need for an efficient way to invite many people to join a social networking site while limiting the distribution of unwanted e-mail messages or spam. Further, there is also a need to enable the software to be flexible enough that it is also capable of inviting a small number of people.

There is a further need to invite people that do not regularly use the Internet, such as people who do not have an e-mail address

A more thorough background of certain social networking concepts is provided in U.S. Pat. No. 7,272,637 filed Jun. 1, 2000, U.S. application Ser. Nos. 11/691,073, 11/691,097 and 11/691,120, each filed on Mar. 26, 2007 and U.S. application Ser. No. 12/134,677 filed on Jun. 6, 2008. Each referenced patent and pending application is incorporated by reference herein in its entirety.

### SUMMARY

In one embodiment, a method is provided for accepting at least one contact identifier as input data in a social networking system. The method comprises providing a text box to a first account holder. The text box enables the first account holder to input the at least one contact identifier as an input string. The method further comprises receiving the input string from the first account holder; parsing the input string to identify each of the at least one contact identifiers contained within the input string; categorizing each contact identifier by category; associating each contact identifier with the first account holder; and storing each contact identifier for use at a subsequent time.

In another embodiment, a method is provided for inviting contacts to join an account holder to form a social network using a social networking software application on a networked computer system. The method comprises providing a text box to the account holder. The text box enables the account holder to input a plurality of contact identifiers as an input string. The method further comprises receiving the input string from the account holder; parsing the input string to identify each of the plurality of contact identifiers contained within the input string; categorizing each contact identifier by category; associating each contact identifier with the account holder; and transmitting an invitation to each contact identifier based on the category of the contact identifier.

### BRIEF DESCRIPTION OF DRAWINGS

The accompanying figures, which are incorporated in and constitute a part of the specification, illustrate various example systems, methods, and results, and are used merely to illustrate various example embodiments. In the drawings and description that follow, like elements are identified with the same reference numerals. The accompanying figures may not be drawn to scale and the proportion of certain elements may be exaggerated for the purpose of illustration.

FIG. 1 is a computer screen display illustrating one embodiment of a text input box.

FIG. 2 is a computer screen display illustrating one example of a populated text input box.

FIG. 3 is a computer screen display illustrating one example invitation window.

FIG. 4 is a computer screen display illustrating one example existing member table.

FIG. 5 is a computer screen display illustrating one example new member table.

FIG. 6 is a computer screen display illustrating one example table of institutional links.

FIG. 7 is a computer screen display illustrating one example error table.

FIG. 8 is a flowchart illustrating an example method for accepting at least one contact identifier as an input string.

FIG. 9 is a flowchart illustrating an example method for inviting contacts to join an account holder to form a social network.

### DETAILED DESCRIPTION

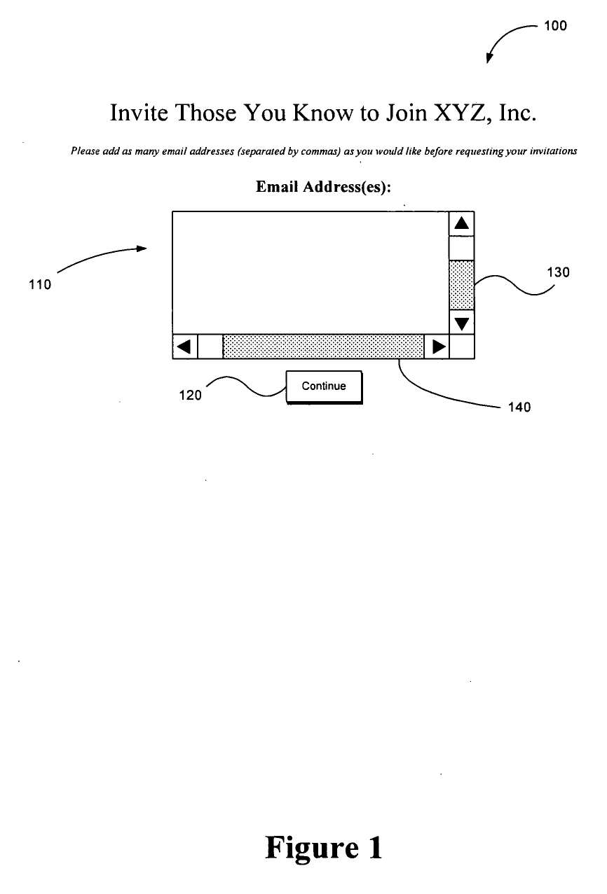

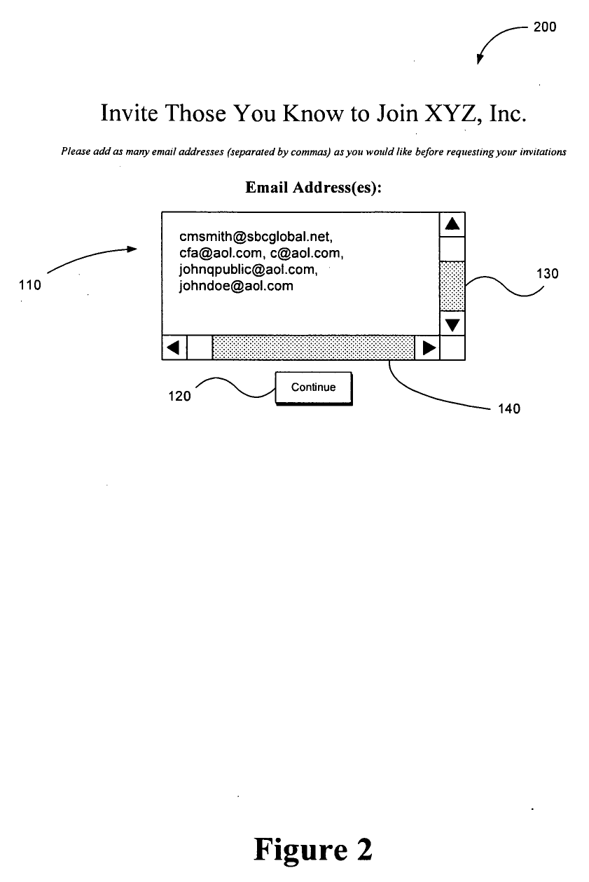

The described system and method employs an intelligent or smart “Input Box” (“IB”). One example IB 110 is shown in computer screen display 100 of FIG. 1. In computer screen display 200 of FIG. 2, IB 110 is shown in a populated state. The IB 110 can accept, handle, and/or process a variety of identifiers such as phone number(s), social security number(s), physical addresses, e-mail addresses and name(s) for example. Although the system and method are described for illustrative purposes as being used with e-mail addresses, it is applicable to other types of identifying information which may be used. Further, the types of identifiers may be intermingled or intermixed together. For example, one may enter phone number(s), e-mail address(es), social security numbers, and/or names into the same IB.

The IB 110 is completed by a user and submitted, such as by selecting “Continue” button 120. The content of IB 110 may be transmitted to or read by a social networking system, and the social networking system stores the e-mail addresses and information about them as invitations in a session. It also sorts the content of IB 110 into the respective invitation types to be processed on screens and/or tables that follow. In other words, the IB 110 can inform the user of the particular category/group to which each invitee belongs. Further, the system can request, or independently determine, based upon predefined settings for each category/group, how each invitee listed in the IB 110 may be contacted. For example, invitees may be contacted by e-mail, phone, fax, IM, text message, chat or any other type of existing or future communication means to invite the invitees to link to the user. If an invitee does not have an e-mail address, the software can direct the computer system to contact the invitee by phone and, through a voice prompt, allow the invitee to accept the link over the telephone.

Optionally, the computer system can mail an invitation to a physical address providing any type of communication means to the invitee in responding to the invitation. Further, the social networking system can mail update copies of the user's information periodically to the user and other subscribers/members to whom they are linked with, including to non-Internet users.

If the user represents an institution that has predefined “attributes” for the invitee to choose, such as Grade, Class, or Teacher, for example, the invitee can select the appropriate choice(s) during the voice prompt. The social networking system can show that the invitee does not have an e-mail address. The social networking system retains information such as which communication means was used to invite each invitee. This information may be provided to the users.

When a user first starts using a social network, the user may have numerous e-mail addresses to enter or upload. Once the user has been using the social networking system for some time, the user may need to enter only one e-mail address, or just a few, at a time. Therefore, if one were to enter just one e-mail address, a few e-mail addresses, or many e-mail addresses, the described system and method provide a simple graphical user interface and a means to process the input data in an efficient and communicative manner.

In one embodiment, identifiers, such as e-mail addresses, entered by the user may be separated by a comma or space. Using scroll bars, such as scroll bars 130 and 140 in FIG. 1, the user can enter a practically unlimited number of e-mail addresses at one time. The system is designed to enable the IB 110 in FIG. 1 to differentiate if an e-mail address is mistyped. The IB 110 may skip certain mistyped e-mail addresses, process the correctly typed addresses, and provide an error table stating which e-mail addresses were not processed. Optionally, the IB 110 may be used to clarify and/or validate specific e-mail addresses.

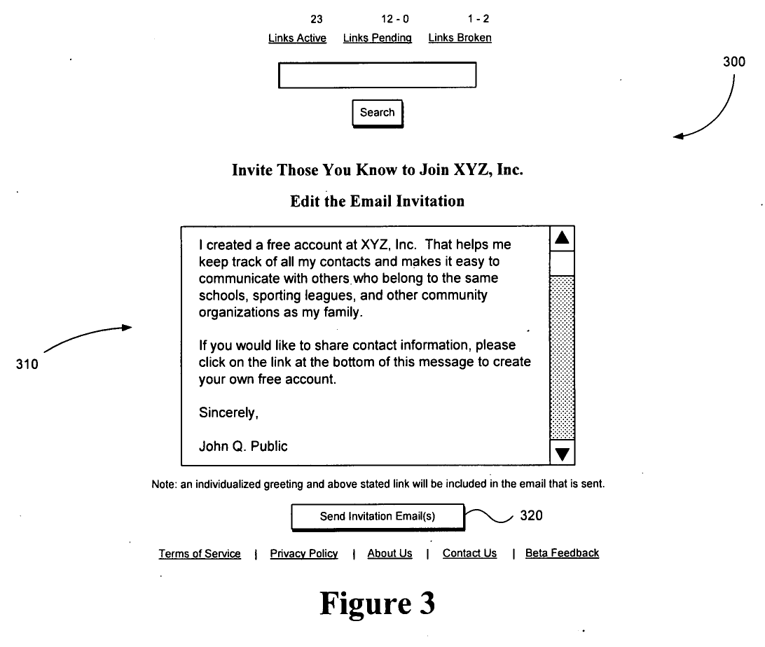

Upon receiving the contents of IB 110, the system may display a computer screen display such as computer screen display 300 depicted in FIG. 3. Display 300 includes a text box 310, for displaying and editing an e-mail invitation. Display 300 further includes a button 320 for sending the e-mail invitation(s). FIG. 3 further displays the number of Links Active representing the number of links the user currently has; Links Pending representing the number of links pending that the user initiated and the number of Links Pending initiated by others; and Links Broken by the user and by others.

A user can copy and paste one or more addresses into the IB 110 from an e-mail list. Alternatively, a user may enter e-mail addresses into his/her e-mail system/application and copy and paste from the e-mail system/application into the IB 110. In short, the example IB 110 enables an increased level of efficiency, but still provides some manual oversight by the user, unlike systems that enable fully automated transfers from e-mail systems/applications. This oversight places the burden of responsibility on the user to avoid spamming all addresses in the user's e-mail contact list. Additionally, the software may request the user to enter the invitee's name to further require additional manual oversight.

After the system processes/reads all e-mail addresses input into the IB 110, if the user were to click another function/screen and/or go to another part of the social networking system platform, when the user returns to the portion of the system enabling e-mail Invitations and displaying the IB 110, the system retains all e-mail addresses that had been previously entered in the IB 110, even though the process was interrupted.

Further, as each e-mail address is processed/read, the system can remove the e-mail address from the session to avoid a duplicate attempt in re-processing. In that case, if the user clicks another function/screen, the processed/read e-mail addresses that should be removed, would not be displayed upon the user's returning to the IB 110 screen. When the user clicks on e-mail invitation function again, the system may repopulate the IB 110 with all of the e-mail addresses that were not in error, and have not already been processed. In other words, the system can remove the e-mail addresses that were processed, and only display the remaining addresses that were not processed. The software may further note which e-mail addresses can not, or should not, be reprocessed for some reason. In one embodiment, the system displays an error table listing errors by type, such as e-mail addresses to which the user is already linked, and invalid e-mail addresses, for example.

In one embodiment, a user may create a database/table having multiple rows, such as contact rows, in a table, with each row representing different individuals belonging to an account. The table may include column headings such as name, address, phone, cell phone, e-mail address, work number, work name, work name, work address, work e-mail address, IM, for example. Each contact row may represent one person in the account such as members of a family, and each cell may represent the data associated with each contact row and the corresponding table/column heading. One contact row may be designated to be the owner of the account (i.e., account holder).

In an alternate embodiment, a person may have multiple contact rows, each row representing a different profile of the same individual, such as a family profile, a work profile or a friend profile, for example, where each profile includes different information that the individual is willing to share with different links.

In one embodiment, if a user had multiple institutional e-mail addressees entered in the e-mail input box, the system may sequentially prompt each institutional link after the user selects the “Continue” button 120 in FIG. 1. One benefit to having the institutional links queued one at a time is to allow the user to choose the specific contact row and/or only the information associated with said contact row (should their database or profile have multiple names, each name representing a contact row) and the institutional attributes, such as grade, class, teacher, school bus, school bus stop, activities, sports, football, soccer, band, chess, after school day care, for example. The user can further choose what information from their own database is to be made public to others also linked with the institution. Each invitee can also have the means to link more than one contact row (i.e., person in their database) to a particular institution. Each invitation, including institutional invitations, may be sent immediately, before the rest of the input data has been processed, upon the user clicking a “continue” button.

In one embodiment, using the IB 110, the social network system reads the input data and categorizes the input data into like categories or groups and displays the results, using a wizard, for each category/group in a table format to the user for further processing by the user (which may include accepting the information in the particular category/group). Each table displays the applicable unique identifier(s) that the user had entered and can further allow the user to make changes to them. If the user had entered just one e-mail address, the wizard progresses to the next screen which is the applicable table for just that category/group. Of course, the wizard may skip the screens that do not have any input data applicable to them.

Depending on the result such as which category/group the e-mail address falls in, the system can prompt the user for additional information. A table may have additional fields to be entered by the user such as name, or another identifying field. In one example, the system can verify the information being entered and may request additional information to be provided based upon the input data.

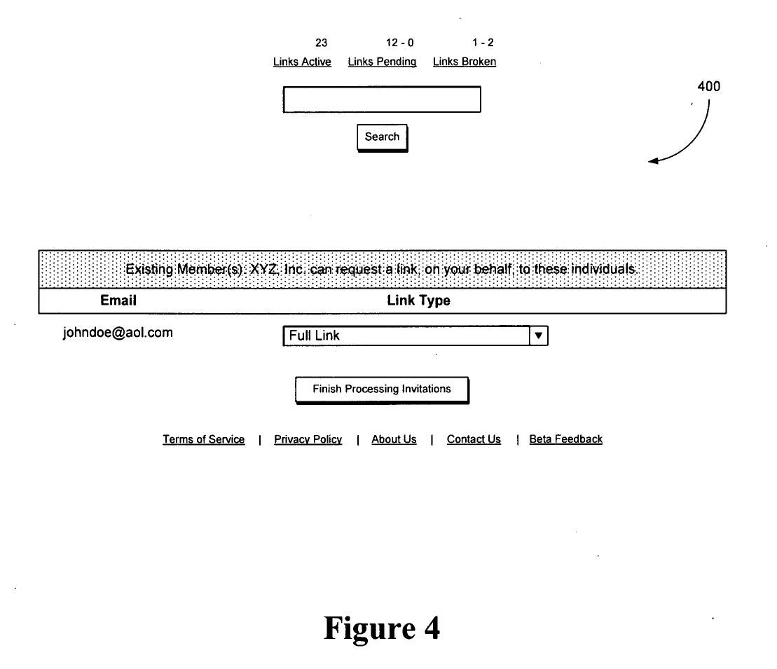

In one embodiment, up to four tables may be displayed, as illustrated in FIGS. 4-7.

Computer screen display 400, illustrated in FIG. 4, is a table that may be displayed in the event an e-mail address entered into IB 110 corresponds to an existing personal account. Although the example illustrated in FIG. 4 only shows a single existing member, multiple existing members may be listed when appropriate. The social networking system determines, such as by searching relevant databases, whether any e-mail address(es) entered by the user belongs to an existing member. If it does belong to an existing member, the software can request a link on the user's behalf, such as by sending an e-mail invitation and/or incrementing the corresponding number of pending links for both the sender and/or receiver. For existing account(s), the table heading may provide an alert, such as:

“Existing Member(s): XYZ, Inc. can request a link, on your behalf, with these individuals”

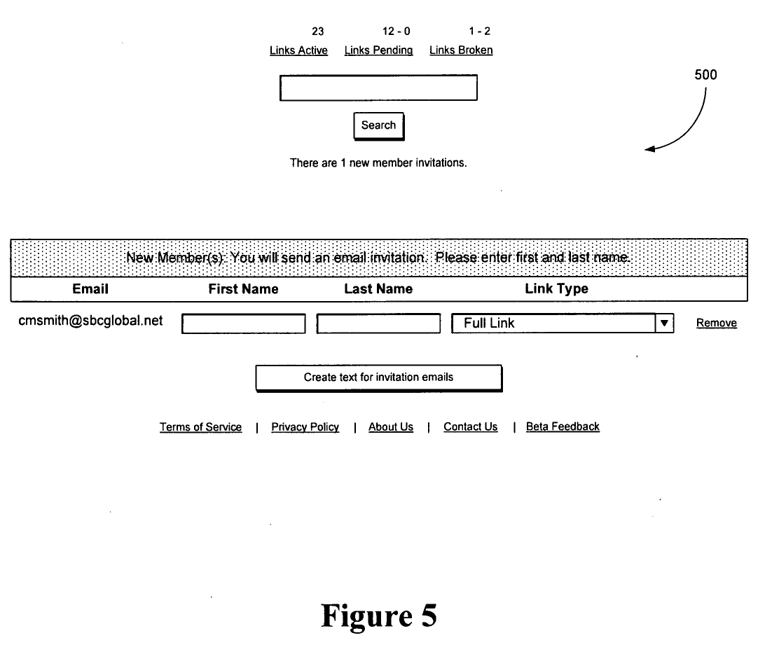

Computer screen display 500, illustrated in FIG. 5, is a table that may be displayed in the event that an e-mail address does not correspond or belong to an existing personal account. Although the example illustrated in FIG. 5 only shows a single new member, multiple new members may be listed when appropriate. If the e-mail address belongs to a new member or new account, the software allows the user to send an e-mail invitation as previously shown in FIG. 3. This table 500 displays the following headings: e-mail address, first name, last name, and type of link. For new accounts, the table heading may provide an alert, such as:

“New Member(s): You will send an e-mail invitation. Please enter first and last name”

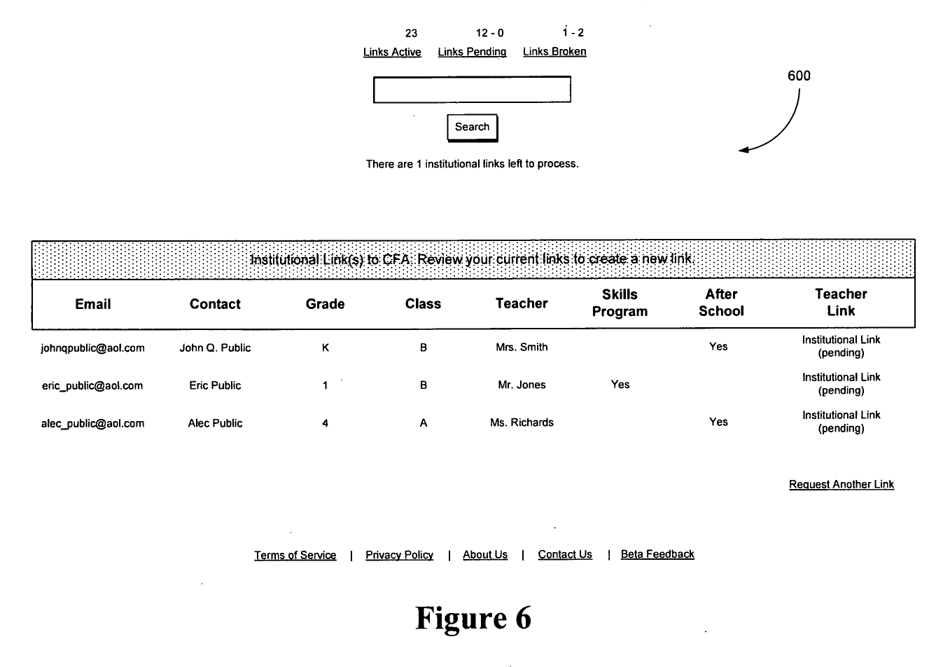

Computer screen display 600, illustrated in FIG. 6, is a table that may be displayed in the event that an e-mail address corresponds to an existing institutional account. The system displays the contact row to be linked and all attributes chosen. In other words, each cell in the institutional table can provide a drop down menu allowing the user to change the contact row or any attribute. FIG. 6 can further display all existing links, including active, pending and broken links to a particular institution. In one embodiment, the social networking system may categorize institutional accounts by industry.

An institution may also use the IB 110 to initiate a link request. The institution may have settings/parameters chosen so that its request is a prerequisite link whereas the institution still must authorize the link after the individual authorizes the link. The purpose is that it provides the institution the means to make any changes to the attributes selected by the individual. It further allows the institution to assign any additional attributes as well, prior to authorizing the link.

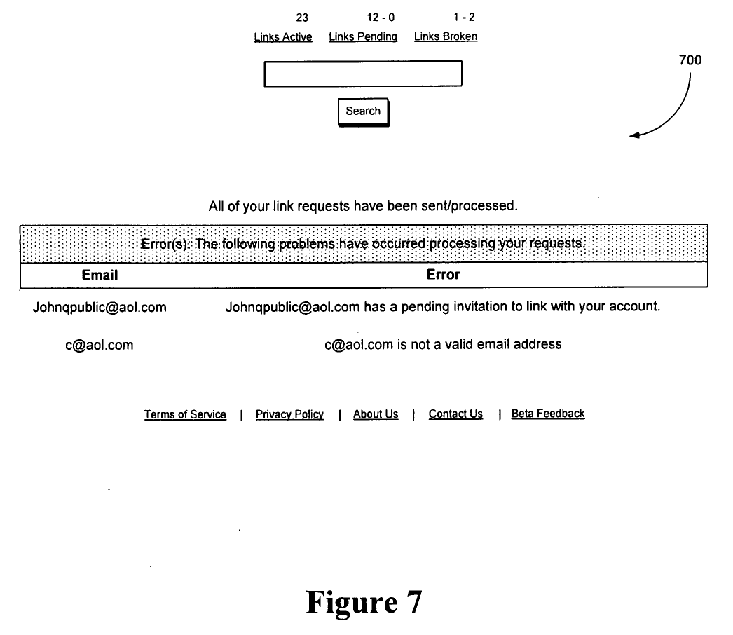

Computer screen display 700, illustrated in FIG. 7, is an error result table that may be displayed in the event that the social networking system identifies errors in the input string of IB 110. This table displays all of the e-mail addresses to which the system cannot send an invitation, and the reason for the error. For example, the table includes any e-mail address to an existing personal account that the user is already linked with, mistyped unique identifiers, and any other error commonly associated with the class of unique identifiers. For error results, the table heading may provide an alert, such as:

Error(s): The following problems have occurred processing your requests.

In some cases, a user, who is an existing member, may request an invitation for a contact row that's not the account holder of another existing member. In such a case, the social networking system provides an option to change the request to the e-mail address belonging to the account holder.

One example method for accomplishing this change is described below:

Consider the case in which janesmith@aol.com is the e-mail address of a member in a contact row to joesmith@aol.com's account. When another user, John Doe with an e-mail address of johndoe@aol.com, enters janesmith@aol.com into the e-mail input box, the social networking system places/processes janesmith@aol.com into the “New member(s) table”. As described above, an invitation is e-mailed to janesmith@aol.com. Optionally, the e-mail may also be sent to joesmith@aol.com, in place of or in addition to janesmith@aol.com.

When an invitation e-mail is sent to a new member that has an e-mail address in the social networking system, for example in a contact row that is not the account holder's, the invitation may provide additional information in the beginning of the e-mail. For example, the social networking system may provide an alert, such as:

“Important message from XYZ, Inc: Our records indicate that your e-mail address is associated with the account of joesmith@aol.com. If this invitation from John Doe (johnddoe@aol.com) should have been sent to joesmith@aol.com, click “here” to move the pending invitation to joesmith@aol.com's account.

If the identified hyperlink is clicked, a login screen will be displayed. The “E-mail Address” field will be populated with joesmith@aol.com, representing the owner of the account, and the cursor will be placed in the “Password” field awaiting input of the password. The social networking system may present an alert on the login screen, such as:

“Our records indicate that your e-mail address is associated with account joesmith@aol.com. By entering the password for joesmith@aol.com, you will redirect the invitation request from janesmith@aol.com to joesmith@aol.com”

Upon the social networking system receiving the password, the software will accomplish the following: 1) It moves pending invitation to joesmith@aol.com. 2) It changes the e-mail address shown in johnddoe@aol.com invitation that is pending from janesmith@aol.com to joesmith@aol.com. It further provides an additional line in the “type field”, similar to institutional pending links that show the attributes chosen, stating: “janesmith@aol.com is associated with joesmith@aol.com” 3) It cancels the link, or invitation, in the e-mail that johnddoe@aol.com sent to “New Member” janesmith@aol.com.

Optionally, in the above example, the social networking system may only show some of joesmith@aol.com's account (e.g., “ . . . ith@aol.com”) in the email to janesmith@aol.com. Further, the social networking system may compare some of the unique information such as address or telephone number associated with janesmith@aol.com with joesmith@aol.com's account to ensure that they are, in fact, related before divulging information about joesmith@aol.com's account to janesmith@aol.com

The social networking system can also address the situation when one user only gave a business card (i.e., partial) link. A business card link is another means for a user to provide a subset of information in their database to a group of links, such as at least one contact row. For example, consider the case where two accounts X and Y already are linked. X gave Y a full link, a link to all of its contact rows, while Y gave X a business card link. Suppose X subsequently asks for a link with a contact row belonging to Y (that is not the account holder's e-mail address nor the business card contact address). The social networking system handles this as described in the first example above. In other words, account Y, via an e-mail invitation can have the opportunity to change the invitation to their email address used by the account holder of Y. When subsequently accessing their “Invitations Pending,” Y can change the type of link that they originally gave to account X. For example, Y could change the link to X from a business card link to include additional contact rows or a full link. In the example above, the full link to all of its contact rows may include the software condensing the contact rows so that each user only has one contact row. In other words, the multiple contact rows, providing different profiles of information for each individual, may be consolidated into one contact row for each individual so that there would not be duplicate information, such as for a user having his/her cell phone in both a work contact row and a personal contact row.

The social networking system can address situations such as if a new account created has an e-mail address that is the same as an e-mail address already in the social networking system. In another embodiment, upon creating a new account (e.g., janesmith@aol.com), the software compares name and address, and alternatively other information as well, from the new account holder's row with contact row belonging to all existing accounts including joesmith@aol.com to determine if the contacts (i.e., any unique identifiers) may be the same. If the software determines that they may be the same, the software, after the account janesmith@aol.com is created, may provide a message, such as: “Important message from XYZ, Inc.: Our records indicate that Jane Smith's contact information is associated with account joesmith@aol.com. You can remove Jane Smith's information from joesmith@aol.com, and have a family link with joesmith@aol.com, by clicking ‘here’.”

If the “here” hyperlink is clicked, a login screen appears. The E-mail Address field is populated with joesmith@aol.com, and the cursor is in the “Password” field awaiting input of the password. Note, a prompt may also be displayed in the login screen, such as:

“By entering the password for joesmith@aol.com, you will remove Jane Smith's contact information from joesmith@aol.com, and have a family link with joesmith@aol.com. Additionally, all institutional links to Jane Smith will be moved to your new account, janesmith@aol.com.” Of course, when this specification refers to “Jane Smith's contact information”, it is referring to her “contact row”.

Note, if the social networking system determines that the e-mail address for the new account does not belong to the same person (after it does the comparison step), the social networking system can inform the new account owner (e.g., janesmith@aol.com) that the social networking system has requested janesmith@aol.com to reconfirm the following e-mail address(es). The social networking system can provide a prompt allowing the user to “CORRECT” or “EDIT” the information that the software is requiring confirmation in. Optionally, the social networking system may further have the existing account holder with the e-mail address verify their information.

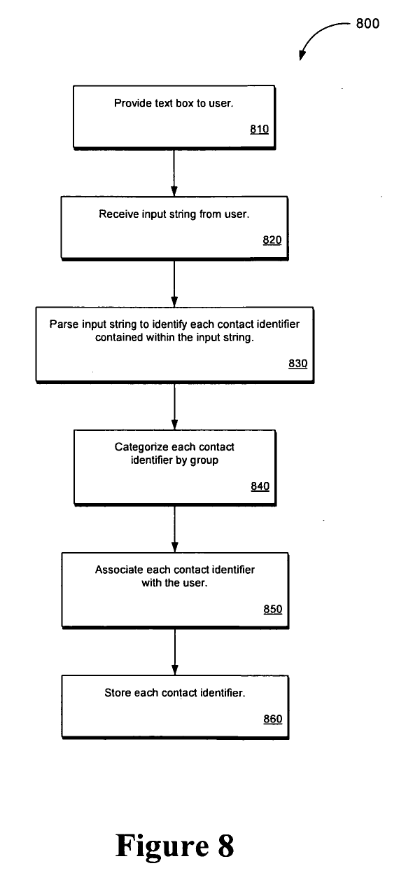

Referring now to FIG. 8, a flowchart is provided illustrating an example method 800 for accepting at least one contact identifier as input data in a social networking system.

According to method 800, a text box is provided to a first account holder at block 810. The text box enables the first account holder to input at least one contact identifier as an input string. At block 820, the input string is received from the first account holder. The input string is parsed to identify each of the at least one contact identifiers contained within the input string, as illustrated by block 830. Each contact identifier is categorized by group, and each contact identifier is associated with the first account holder at blocks 840 and 850, respectively. At block 860, each contact identifier is stored.

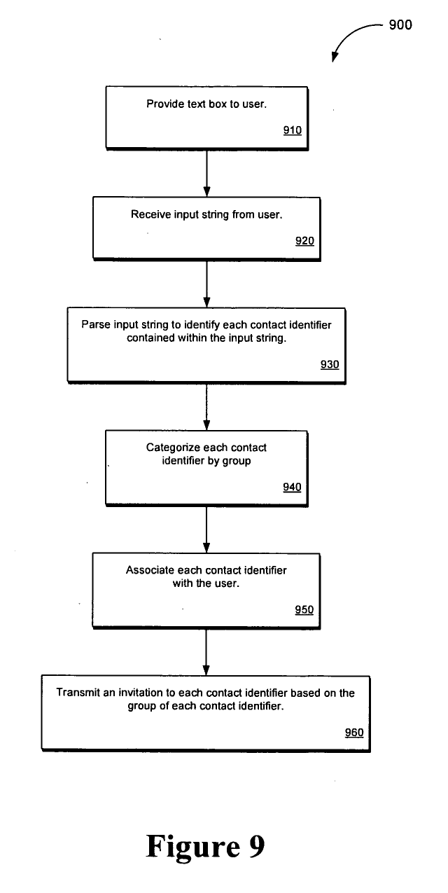

Referring now to FIG. 9, a flowchart is provided illustrating an example method 900 for inviting contacts to join an account holder to form a social network using a social networking system.

According to method 900, a text box is provided to a first account holder at block 910. The text box enables the first account holder to input at least one contact identifier as an input string. At block 920, the input string is received from the first account holder. The input string is parsed to identify each of the at least one contact identifiers contained within the input string, as illustrated by block 930. Each contact identifier is categorized by group, and each contact identifier is associated with the first account holder at blocks 940 and 950, respectively. At block 960, an invitation is transmitted to each contact identifier based on the group of each contact identifier.

From the above description of the exemplary systems and methods, those skilled in the art will perceive improvements, changes and modifications to the systems and methods. Such improvements, changes and modifications within the skill of the art are intended to be covered by the present application.

Accordingly, it is to be understood that the drawings and description in this disclosure are proffered to facilitate comprehension of applicant's systems and methods, and should not be construed to limit the scope thereof. It should be understood that various changes, substitutions and alterations can be made without departing from the spirit and scope of the disclosure

What is claimed is:

1. A method for accepting at least one contact identifier as input data in a social networking system, comprising:
providing a text box to a first account holder, the text box enabling the first account holder to input the at least one contact identifier as an input string;
receiving the input string from the first account holder;
parsing the input string to identify each of the at least one contact identifiers contained within the input string;
categorizing each contact identifier by category;
associating each contact identifier with the first account holder; and
storing each contact identifier for use at a subsequent time.

2. The method of claim 1 wherein categorizing each contact identifier by category includes identifying each contact identifier as belonging to one of a list of categories including social security number, name, e-mail address, physical address, telephone number, facsimile number, pager number and input error.

3. The method of claim 1 further comprising using at least one of the plurality of contact identifiers to deliver a message.

4. The method of claim 3 further including constructing the message, the message including an invitation to be associated with the first account holder.

5. The method of claim 1 further comprising:
identifying that a first contact identifier of the at least one contact identifier is associated with a second account holder;
constructing a message to the second account holder, the message including an invitation to be associated with the first account holder;
delivering the message to the second account holder;
requesting confirmation from the second account holder accepting the invitation to be associated with the first account holder; and
associating the second account holder with the first account holder.

6. The method of claim 1 further comprising:
identifying that a first contact identifier of the at least one contact identifier is associated with a second account holder; and
incrementing a number of pending links.

7. A method for inviting contacts to join an account holder to form a social network using a social networking software application on a networked computer system, comprising:
providing a text box to the account holder, the text box enabling the account holder to input a plurality of contact identifiers as an input string;
receiving the input string from the account holder;
parsing the input string to identify each of the plurality of contact identifiers contained within the input string; and
categorizing each contact identifier by category;
associating each contact identifier with the account holder; and
transmitting an invitation to each contact identifier based on the category of the contact identifier.

8. The method of claim 7, further comprising:
receiving a response from a contact associated with a first contact identifier of the plurality of contact identifiers, the response indicating an acceptance to join the social network; and
creating a link between the first contact and the account holder.
